(19) United States
(12) Patent Application Publication
(10) Pub. No.: US 2016/0340894 A1
(43) Pub. Date: Nov. 24, 2016

(54) SPRAY FOAM RETENTION BARRIER

(71) Applicant: Leonidis Patrick McGonigal, Seguin, TX (US)

(72) Inventor: Leonidis Patrick McGonigal, Seguin, TX (US)

(21) Appl. No.: 15/160,925

(22) Filed: May 20, 2016

Related U.S. Application Data
(60) Provisional application No. 62/164,282, filed on May 20, 2015.

(51) Int. Cl. E04B 1/76; E04B 1/84; B32B 5/02; E04B 1/64; B05D 1/02; B32B 3/06; E04F 21/08; E04B 1/88

(52) U.S. Cl. CPC E04B 1/7629; E04B 1/7604; E04F 21/085; E04B 1/84; E04B 1/88; E04B 1/64; B05D 1/02; B32B 3/06; B32B 5/02; B32B 2607/00; B32B 2307/7265

(57) ABSTRACT

A foam retention barrier includes a broad pliable substrate substantially impermeable to spray foam; and a field of spray foam retainers extending across a major portion of the substrate. A method of installing spray foam insulation including affixing a broad pliable substrate to structural building members. The substrate includes a substantially spray-foam-impermeable layer and presenting a field of spray foam retainers across a major portion thereof. The method further includes applying a spray foam onto the field of spray foam retainers on the substrate. The substrate provides a foam-impermeable barrier between the building sheathing and the spray foam and wherein the field of spray foam retainers serve to retain the spray foam on the substrate adjacent the building sheathing.

### CROSS-REFERENCE TO RELATED APPLICATIONS

This application claims priority to provisional application Ser. No. 62/164,282 filed May 20, 2015 and titled “Barrier for Installation of Spray-in Foam”, which is incorporated herein by reference in its entirety.

### FIELD OF INVENTION

This invention generally relates to insulation systems, and in particular to spray-in foam insulation systems.

### BACKGROUND OF THE INVENTION

Spray-in foam is increasingly used in place of loose-fill or batting insulation in new construction and remodeling projects, particular in meal building construction. Spray-in foam can provide certain advantages such as a sealed building envelope or custom thicknesses and R values. Use of existing spray-in foam systems with metal buildings can present certain challenges and disadvantages. In particular, polyurethane spray foam can bond tightly to structural and non-structural framing members and external sheathing thereby preventing the non-destructive removal, maintenance and/or replacement of the exterior wall sheathing. Applying spray polyurethane insulation directly against framing members and roof or wall sheathing/sheeting can create a quasi-composite structure which prevents the individual removal of damaged panels/sheets for replacement or repair without destroying or damaging the framing members, insulation and adjacent sheathing/sheeting.

Direct bonding of spray-in foam can also lead to difficulty in repairing leaks or replacing windows. For example, if a window or frame is leaking water into the building, adhesion of the spray foam across the leaking member and adjacent panels can make replacement difficult without causing additional cosmetic or structural damage.

Similarly, metal sheathing and cured spray foams generally have different coefficients of thermal expansion which can lead to buckling of sheathing from the differences in the degree of expansion and contraction. Thermal expansion differences can also lead to elongation of through-holes around fasteners and loosening or elongation of fasteners, creating leaks and cosmetic or structural compromise. Additionally, some foams can trap moisture adjacent metal sheathing, which can lead to corrosion or otherwise compromise the life or performance of the building materials.

Despite some disadvantages, it has become common practice to spay foam directly onto the interior face of exterior cladding sheathing. Earlier proposed spray-in foam systems, such as that taught by U.S. Pat. No. 6,584,749 to Sperber, have sought to enhance the bonding of spray-in foam to metal panels. Indeed, Sperber teaches that “the sprayed insulation with foam, when it contacts the metal, does no desirably or sufficiently adhere.” Sperber proposed a stucco-wire type rigid mesh which would help support the weight of the mixed cellulose particulate and foam against sagging while still allowing for passage of the foam therethrough “such that at least some or portions of the insulation material exist or extends from the inner surface of the web member” to “contact the outer surface of the building member.” Sperber does not address the disadvantages of direct bonding of spray-in foam to metal building materials.

Accordingly, improvements are sought in use of spray-in foam insulation in metal buildings and other construction applications.

### SUMMARY OF THE INVENTION

While the way that the present invention addresses the disadvantages of the prior art will be discussed in greater detail below, in general, the present invention provides a two-sided barrier material comprising at least an outer layer or face and an inner layer or face bonded together by any suitable means, e.g., chemical, mechanical, heat bonding, etc. The outer layer comprises a durable and foam-impermeable barrier layer. In some cases, the foam-impermeable barrier layer may be air-permeable while also being substantially water-impermeable. Thus, the outer foam-impermeable barrier layer can allow for air transport and evaporative moisture transport while providing a barrier to liquid water and a barrier to adhesion of foam to adjacent building surfaces.

The inner layer comprises a field of foam retention features for mechanically engaging, e.g., embedding into or receiving foam sprayed across the inner layer. Thus, the inner layer serves to bond the spay foam to the back of the foam-impermeable outer layer. In some embodiments, the field of foam retention features can include a tufted fabric, e.g., with fibers or filaments generally arranged with random entangled loops and ends. Other foam retention features can include one or more of loops, hooks, tufted fibers, barbs, waft or weave profiles and/or interstices between any of the above. Any number of additional layers or materials may be used in forming the substrate. For example, reflective sheets, scrims, reinforcing fibers and the like may be added to the layered structure of barrier material.

In some embodiments, a single-layer barrier material may be formed with both a foam-impermeable outer face and a foam-retaining opposite face. The barrier material can include any number or combination of woven, non-woven, spun-bond, spun-laid, polypropylene, polyethylene, PVC, vinyl, and other materials.

In some embodiments, a foam-impermeable material provides an adhesion barrier adjacent framing members and structural and non-structural sheathing allowing for application of spray-in foam that is ultimately independent from the building exterior cladding/sheathing. The foam barrier allows for installation of spray-in foam without bonding of the cured or hardened foam to the building cladding, such as metal or vinyl exterior siding, sheathing or roofing panels. Providing a barrier to maintain the foam independent of the cladding allows for later non-destructive removal of cladding panels, e.g., for inspection, maintenance, replacement, or repair. Thus, one aspect of the invention features a barrier material that provides proper adhesion of foam to an installed barrier system while preventing adhesion of the foam to the building cladding/sheathing.

The system is configured to be installed on one side of a structural or non-structural framing member, and between the framing member and its adjacent structural or non-structural sheet, sheathing, panel, or covering. The barrier can be installed over the structural building members, e.g., girt or purlin vertical or horizontal framing members, using any number of adhesives, tapes, clips, conventional fasteners, hook and loop fasteners, and the like. The barrier exhibits sufficient tensile strength to support the weight of the spray-in foam up high vertical walls and suspended between spanners across a ceiling. Spray-in foam is then deposited on the inner-most layer while the outermost layer presents a substantially non-stick surface to the building cladding. Curing of the foam produces a substantially rigid insulative panel adjacent the cladding, yet independent from and not adhered to the cladding.

One aspect of the invention features, in some embodiments, a spray foam retention barrier including a broad pliable substrate defining a first outer face and a second inner face. The first outer face presenting a foam-impermeable material and the second inner face presenting a field of spray foam retainers configured to mechanically engage spray-foam applied thereon.

In some embodiments, the first outer face comprises one of a plastic film and a metallic foil. In some embodiments, the first outer face comprises at least one of a woven fabric and a non-woven fabric, spun bond fabric, and spun laid fabric.

In some embodiments, the second inner face presenting a field of foam retainers comprises at least one of a field of hooks, a field of loops, a field of tufted fibers, and a field of randomly oriented fiber ends. The foam retainers are configured to promote bonding of the applied spray-foam across the field. In some embodiments, the field of foam retainers is integrally formed with the foam-impermeable barrier.

In some embodiments, the foam retention barrier further includes a reinforced border portion for fastening to structural or non-structural building members.

In some embodiments, the foam retention barrier further includes an adhesive strip for positioning the foam retention barrier relative to structural building members such as girts or purlins. The barrier can be provided across vertical walls and ceilings to form a building envelope prior to installation of sheathing and roofing panels.

In some embodiments, the first outer face comprises a stretchable substrate.

In some embodiments, the foam retention barrier further includes at least one of a reflective layer, scrim, and reinforcing mesh.

In some embodiments, the first outer face comprises at least one of polypropylene, polyethylene, PVC, and vinyl.

Another aspect of the invention features, in some embodiments, a foam retention barrier including a broad pliable substrate substantially impermeable to spray foam and a field of spray foam retainers extending across a major portion of the substrate.

In some embodiments, the field of foam retainers includes at least one of a field of hooks, a field of loops, a field of tufted fibers, and a field of randomly oriented fiber ends.

In some embodiments, the field of foam retainers is integrally formed with the substrate.

In some embodiments, the foam retention barrier further includes at least one of a reflective layer, and a reinforcing mesh. In some embodiments, the barrier is laminated to a sound deadening material, fiberglass blanket insulation, and the like.

In some embodiments, the substrate is substantially water-impermeable.

In some embodiments, the substrate is air-permeable.

Another aspect of the invention features, in some applications, a method of installing spray foam insulation. The method includes affixing a broad pliable substrate to extend between structural or nonstructural building members, the substrate comprising a substantially spray-foam-impermeable layer and presenting a field of spray foam retainers across a major portion thereof. The method further includes applying a spray-in foam onto the field of spray foam retainers on the substrate; wherein the substrate provides a foam-impermeable barrier between the building sheathing or cladding and the spray foam and wherein the field of spray foam retainers serve to retain the spray foam on the substrate adjacent the building sheathing.

In some applications, the method further includes curing the spray foam to produce a substantially rigid insulative panel adjacent to but substantially independent from the building sheathing.

In some applications, the rigid insulative panel is substantially independent from the building sheathing in terms of thermal expansion and thermal contraction.

In some applications, the method further includes replacing the building sheathing substantially without disrupting the substantially rigid insulative panel.

### BRIEF DESCRIPTION OF THE DRAWINGS

A more complete understanding of the present invention may be derived by referring to the detailed description and claims when considered in connection with the Figures, wherein like reference numerals refer to similar elements throughout the Figures, and

FIG. 1 illustrates a foam retention barrier system according to one embodiment installed between building members, e.g., girts and purlins, or framing, adjacent building sheathing.

FIG. 2 illustrates a roll of broad pliable foam retention barrier material according to one embodiment presenting a field of spray foam retainers.

FIG. 3 illustrates one embodiment of the barrier material of FIG. 2 presenting a field of foam retainers defining loops.

FIG. 4 illustrates one embodiment of the barrier material of FIG. 2 presenting a field of foam retainers defining fiber tufts.

FIG. 5 illustrates one embodiment of the barrier material of FIG. 2 presenting a field of foam retainers defining random projections such as loose fiber ends.

FIGS. 6A-B illustrates embodiment of the barrier material of FIG. 2 installed to extend between adjacent structural building members.

FIG. 7A illustrates one embodiment of the barrier material of FIG. 2 presenting a field of foam retainers defining random projections such as loose fiber ends prior to application of spray-in foam.

FIG. 7B illustrates one embodiment of the barrier material of FIG. 2 presenting a field of foam retainers defining random projections such as loose fiber ends after application of spray-in foam.

### DETAILED DESCRIPTION

The following description is of exemplary embodiments of the invention only, and is not intended to limit the scope, applicability or configuration of the invention. Rather, the following description is intended to provide a convenient illustration for implementing various embodiments of the invention. As will become apparent, various changes may be made in the function and arrangement of the elements described in these embodiments without departing from the scope of the invention as set forth herein. It should be appreciated that the description herein may be adapted to be employed with alternatively configured barriers having different shapes, thicknesses, widths, components, layers, retention mechanisms and the like and still fall within the scope of the present invention. Thus, the detailed description herein is presented for purposes of illustration only and not of limitation.

Reference in the specification to “one embodiment” or “an embodiment” is intended to indicate that a particular feature, structure, or characteristic described in connection with the embodiment is included in at least an embodiment of the invention. The appearances of the phrase “in one embodiment” or “an embodiment” in various places in the specification are not necessarily all referring to the same embodiment.

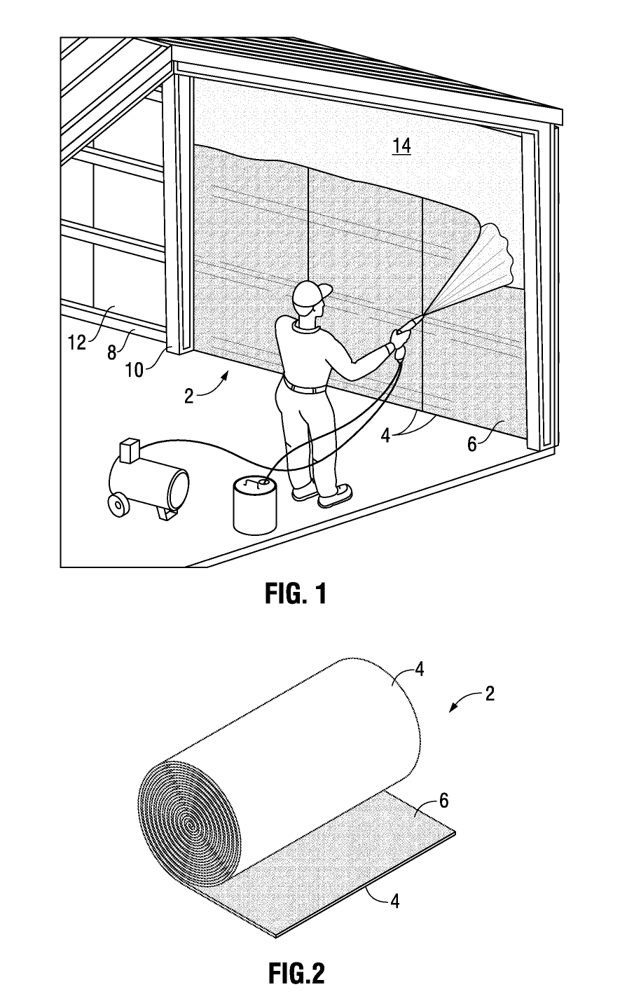

With reference now to FIG. 1, a foam retention barrier 2 according to one embodiment of the present invention includes a broad pliable substrate 4 presenting a field of foam retention features 6. Substrate 4 is affixed adjacent a rigid building material 8, such as vertical or horizontal framing members 8 or 10, including girts, purlins, studs, or the like. A spray foam 14 is received on substrate 4 with foam retention features 6 embedded therein. Barrier 2 serves to maintain the cured foam independent from the exterior cladding or sheathing 12 of the structure.

With reference now to FIG. 2, a foam retention barrier 2 is shown according to one embodiment of the present invention presenting a field of spray-foam retainer features 6. In some embodiments the substrate comprises at least one of a plastic film and metallic foil.

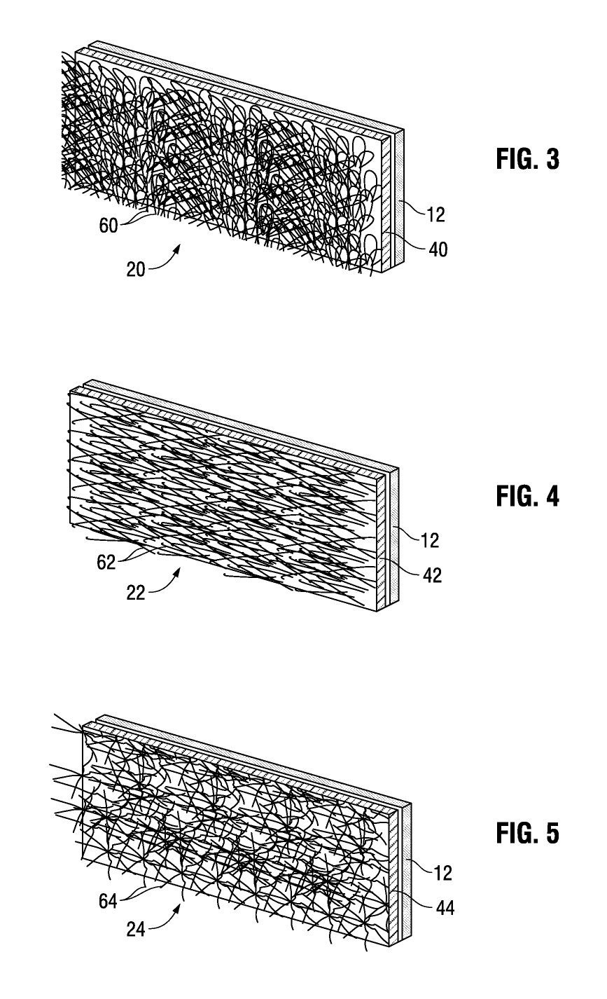

With reference now to FIG. 3, a foam retention barrier 20 is shown according to one embodiment in which the field of foam retainers defines a plurality of loops 60. The loops can be formed by any suitable process including, stitching, and spin-laying. The field of retainers can be embedded into the substrate 40, passed through the substrate, or bonded thereto. Barrier 20 is installed adjacent, but independent of sheathing 12 and maintains the cured foam applied thereon independent of sheathing 12.

With reference now to FIG. 4, a foam retention barrier 22 is shown according to one embodiment presenting a field of foam retainers defining fiber tufts 62 extending across one face of substrate 42.

With reference now to FIG. 5, a foam retention barrier 24 is shown according to one embodiment in which the field of spray foam retainers defines random projections 64 such as loose fiber ends extending across one face of substrate 44.

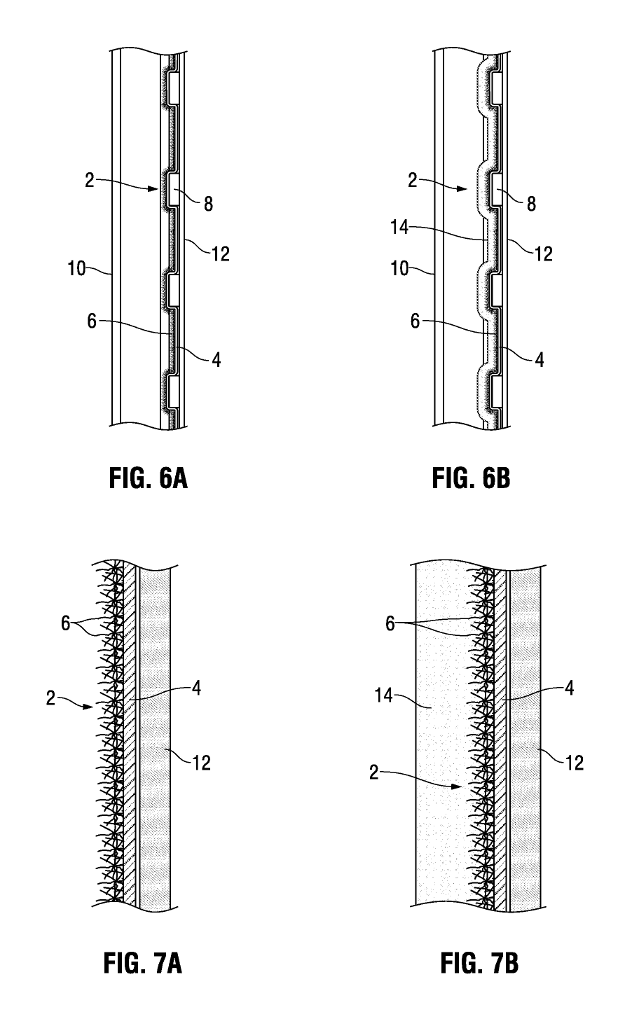

With reference to FIGS. 6A-B, spray-foam retention barrier 2 may be installed on the interior or exterior of structural members 8 or 10, or a combination, e.g., by weaving between horizontal members. Sheathing 12 is then affixed to members 8 or 10 adjacent barrier 2 and spray foam 14 is applied to the interior face of barrier 2. Thus, while some spray foam 14 may be tolerated on structural members 8 and 10, it is preferable that barrier 2 and the cured spray foam 14 remain substantially independent of sheathing 12.

With reference to FIG. 7A, spray-foam retention barrier 2 is installed to present a field of foam retainers 6 defining random projections such as loose fiber ends prior to application of spray-in foam. With reference to FIG. 7B, the loose fiber ends are embedded into the spray foam during application of spray-in foam, to provide a composite insulative panel or layer when the foam is cured. The composite insulative panel is substantially independent of the adjacent structural members such that either can be repaired or replace without major disruption to the other.

In some embodiments, barrier substrate 4 is formed by nip extrusion of a film. In some applications the foam retention features 6 are integrally formed with substrate 4, e.g., via coextrusion or spin-bonding. In some embodiments, the foam retention features are at least one of adhered, heat bonded, and embedded on the substrate. It is understood that any process now known or later developed for forming a foam-impermeable substrate and a field of foam retention features may be used in accordance with the present invention.

Accordingly, the present invention provides a spray-foam retention barrier that serves both to support spray-in foam during installation and to prevent direct adhesion of the spray-in foam to adjacent structural panels. Similarly, while the present invention has been described herein as a barrier for installation of spray-in foam, the present invention may be readily used with any number of other similar sprayable or curable materials now known or hereafter developed.

Finally, while the present invention has been described above with reference to various exemplary embodiments, many changes, combinations and modifications may be made to the exemplary embodiments without departing from the scope of the present invention. For example, the various components may be implemented in alternative ways. These alternatives can be suitably selected depending upon the particular application or in consideration of any number of factors associated with the operation of the device. In addition, the techniques described herein may be extended or modified for use with other types of devices. These and other changes or modifications are intended to be included within the scope of the present invention.

What is claimed is:

1. A spray foam retention barrier comprising:
a pliable substrate defining a first outer face and a second inner face;
the first outer face presenting a foam-impermeable material; and
the second inner face presenting a field of spray foam retainers configured to mechanically engage spray-foam applied thereon.

2. The foam retention barrier of claim 1, wherein the first outer face comprises one of a plastic film and a metallic foil.

3. The foam retention barrier of claim 1, wherein the first outer face comprises at least one of a woven fabric and a non-woven fabric, spun bond fabric, and spun laid fabric.

4. The foam retention barrier of claim 1, wherein the second inner face presenting a field of foam retainers comprises at least one of a field of hooks, a field of loops, a field of tufted fibers, and a field of randomly oriented fiber ends.

5. The foam retention barrier of claim 4, wherein the field of foam retainers is integrally formed with the foam-impermeable barrier.

6. The foam retention barrier of claim 1, further comprising a reinforced border portion for fastening to structural building materials.

7. The foam retention barrier of claim 1, further comprising an adhesive strip for adhering the foam retention barrier to structural building members.

8. The foam retention barrier of claim 1, wherein the first outer face comprises a stretchable substrate.

9. The foam retention barrier of claim 1, further comprising at least one of a reflective layer, scrim, and reinforcing mesh.

10. The foam retention barrier of claim 1, wherein the first outer face comprises at least one of polypropylene, polyethylene, PVC, and vinyl.

11. A foam retention barrier comprising:
a broad pliable substrate substantially impermeable to spray foam; and
a field of spray foam retainers extending across a major portion of the substrate.

12. The foam retention barrier of claim 11, wherein the field of foam retainers comprises at least one of a field of hooks, a field of loops, a field of tufted fibers, and a field of randomly oriented fiber ends.

13. The foam retention barrier of claim 11, further comprising at least one of a reflective layer, a reinforcing mesh, and a sound deadening layer.

14. The foam retention barrier of claim 11, wherein the substrate is substantially water-impermeable.

15. The foam retention barrier of claim 14, wherein the substrate is air-permeable.

16. A method of installing spray foam insulation, the method comprising:
affixing a broad pliable substrate to extend between structural building members, the substrate comprising a substantially spray-foam-impermeable layer and presenting a field of spray foam retainers across a major portion thereof; and
applying a spray foam onto the field of spray foam retainers on the substrate;
wherein the substrate provides a foam-impermeable barrier between a building sheathing and the spray foam and wherein the field of spray foam retainers serves to retain the spray foam on the substrate adjacent the building sheathing.

17. The method of claim 16, wherein the structural building member comprises at least one of a girt and a purlin.

18. The method of claim 16, further comprising curing the spray foam to produce a substantially rigid insulative panel adjacent to but substantially independent from the building sheathing.

19. The method of claim 18, wherein the rigid insulative panel is substantially independent from the building sheathing in terms of thermal expansion and thermal contraction.

20. The method of claim 18, further comprising replacing the building sheathing substantially without disrupting the substantially rigid insulative panel.
